(19) United States
(12) Patent Application Publication
(10) Pub. No.: US 2014/0271239 A1
(43) Pub. Date: Sep. 18, 2014

(54) SPARK SUPPRESSION BALLAST CLOSELY COUPLED TO EMITTER ELECTRODE OF ION GENERATOR

(71) Applicant: PANASONIC PRECISION DEVICES CO., LTD., KUMAMOTO (JP)

(72) Inventors: Kenneth Honer, Santa Clara, CA (US); Nels Jewell-Larsen, San Jose, CA (US); Wilbur Lau, Fremont, CA (US)

(21) Appl. No.: 13/798,640

(22) Filed: Mar. 13, 2013

(51) Int. Cl. H01T 23/00; H01T 21/00; H02H 9/04

(52) U.S. Cl. CPC H01T 23/00; H02H 9/04; H01T 21/00
USPC 417/49; 361/230; 361/91.1; 29/825

(57) ABSTRACT

By directly connecting, ballast to an emitter electrode of an ion generator (e.g., a corona-discharge device), a rapid and self-corrective reduction in emitter-to-collector voltage may be provided responsive to an increase in current characteristic of incipient sparking discharge. Voltage levels in the emitter-to-collector gap can be rapidly reduced based on voltage drop across the ballast that, while negligible under nominal ion current conditions, transiently increases in the event of a sparking discharge. As a result, the portion of supply voltage (typically multi-KV supply voltage) across the emitter-to-collector gap is transiently reduced to levels below a current breakdown voltage and, indeed, field intensity proximate to the emitter is transiently reduced below levels otherwise necessary to sustain ion generation.

### BACKGROUND

1. Field

The present application relates to devices that generate ions and/or electrical fields to motivate flow of fluids, such as air, and/or charged particulates.

2. Related Art

Many modern electronic devices (including desktop and laptop computers, all-in-one computers, compute tablets, televisions, video displays and projectors) employ forced air flow as part of a thermal management solution. Mechanical air movers such as fans or blowers have conventionally been employed in many such devices. However, in some applications and devices, mechanical air mover operation may result in undesirable levels of noise or vibration that may degrade the user experience. In some cases, physical scale or flow paths that would otherwise be necessary to accommodate a mechanical air mover may be incompatible with, or unacceptably limit, the design, scale or form factor of a particular design. Worse still, at the extremely thin device form factors popular in certain consumer electronics (e.g., laptops, pad-type computers, televisions, smart phones, book readers and media players), mechanical air mover designs (if even accommodatable) tend to exhibit poor cooling efficiencies. As a result, battery life may be adversely affected or, as a practical matter, device performance throttled to a level compatible with passive cooling.

Technologies have been developed that employ electric fields and principles of ionic movement of a fluid to motivate air flow. Devices that operate based on such principles are variously referred to in the literature as ionic wind machines, electric wind machines, corona wind pumps, electro-fluid-dynamics (EFD) devices, electrohydrodynamic (EHD) thrusters and EHD gas pumps. Some aspects of the technology have been exploited in devices referred to as electrostatic air cleaners or electrostatic precipitators and, indeed, some practical large scale device applications of the technology date back to the early 1900s. More recently, researchers have considered the utility of EHD air movers as part of a thermal management solution in consumer electronics devices. See generally, N. E. Jewell-Larsen, H. Ran, Y. Zhang, M. Schwiebert and K. A. Honer, Electrohydrodynamic (EHD) Cooled Laptop, in proceedings of 25th Annual Semiconductor Thermal Measurement and Management Symposium (March 2009).

In some cases, an ion flow or EHD air mover may improve cooling efficiency and thermal management in some devices and/or applications, while reducing noise, vibration and power consumption. Likewise, EHD air mover designs may provide or facilitate systems or devices that have reduced overall device lifetime costs, device size or volume, and/or improved electronic device performance or user experience.

In some cases and or operating environments, sidewalls of a flow channel in which fluid (e.g., air) is motivated may be, or become, susceptible to surface accumulations of contaminants or charge carriers that can (given local strength of an applied electric field) provide a spark or shunting current path between emitter and collector electrodes. In some cases, the electrodes themselves may accumulate contaminants that can likewise contribute to conditions that support or increase likelihood of sparking discharge. These effects can be undesirable for a number of reasons including the acoustic signatures that can be generated, the surface pitting and damage that can occur and excess ozone (0₃) that can result. Similar design challenges may present in other corona discharge devices, at least at some form factors and in some applications.

Ozone (0₃), while naturally occurring, can also be produced during operation of various electronics devices including EHD devices, photocopiers, laser printers and electrostatic air cleaners, and by certain kinds of electric motors and generators, etc. At high concentrations, ozone can be undesirable and, accordingly, techniques to reduce ozone concentrations are desired. Indeed, techniques have been developed to catalytically or reactively break down ozone (O₃) into the more stable diatomic molecular form (O₂) of oxygen. See e.g., U.S. Pat. No. 6,603,268 to Lee and U.S. Patent Application Publication 2010-0116469, naming Jewell Larsen et al. as inventors, each of which is commonly-owned by the assignee of the present application.

Improved techniques are desired for managing conditions that may otherwise lead to sparking discharge. For example, techniques to reduce or mitigate accumulation of contaminants are desired. Likewise, techniques are desired that tend to mitigate impact of contaminants that may nonetheless accumulate and of other contributors to sparking or shunting currents. Finally, designs and techniques are desired for suppressing incipient sparking discharge if and when it occurs.

### SUMMARY

It has been discovered that by very closely coupling, indeed by directly connecting, ballast to an emitter electrode of an ion generator, e.g., a corona-discharge device, a rapid and self-corrective reduction in emitter-to-collector voltage may be provided responsive to an increase in current characteristic of incipient sparking discharge. Voltage levels in the emitter-to-collector gap can be rapidly reduced based on voltage drop across the ballast that, while negligible under nominal ion (or corona) current conditions, transiently increases in the event of a sparking discharge. As a result, the portion of supply voltage (typically multi-KV supply voltage) across the emitter-to-collector gap is transiently reduced to levels below a current breakdown voltage and, indeed, field intensity proximate to the emitter is transiently reduced below levels otherwise necessary to sustain ion generation.

In some embodiments, a ballast circuit is provided in the form of a circuit board or other electrical assembly with an electrical attach point to which a wire-type emitter electrode may be directly connected (e.g., by solder attachment). In some cases, the ballast board or other electrical assembly is sized and configured for placement within protective cavity into which the wire-type emitter electrode and a high voltage supply lead are both terminated and thereafter “potted” using an ozone resistant potting compound such as polyurethane.

In some embodiments in accordance with the present invention(s), an apparatus includes an elongate wire emitter electrode and at least one collector electrode energizable to establish an ion current therebetween, together with a ballast circuit in direct electrical contact with the elongate wire emitter electrode to close at least a portion of a current path through the emitter and collector electrodes to, or from, a high voltage supply terminal. In some cases, the ballast circuit includes a circuit board with a termination point to which one end of the elongate wire emitter electrode is soldered.

In some cases or embodiments, the apparatus further includes a structural frame formed substantially of dielectric material and including a cavity in which the ballast circuit is positioned. The soldered end mechanically fixes the elongate wire emitter electrode under tension. In some cases, an encapsulating volume of the cavity surrounding the ballast circuit and the soldered end of the elongate wire is substantially filled with potting material. In some cases, the potting material includes an ozone resistant polyurethane.

In some cases or embodiments, the apparatus is configured as an EHD fluid mover to motivate fluid flow past the emitter and collector electrodes. In some cases or embodiments, the apparatus further includes an enclosure having inlet and outlet ventilation boundaries. The EHD fluid mover is disposed within the enclosure to, when energized, motivate air flow along a fluid flow path between the inlet and outlet ventilation boundaries and a heat source is thermally coupled to transfer heat into the motivated air flow.

In some cases or embodiments, the ballast circuit consists essentially of a resistive load providing between 100 KO and 0.5 MΩ of resistance in the current path. In some cases or embodiments, the ballast circuit includes a depletion mode field-effect transistor (FET) coupled into the current path. In some cases or embodiments, a gate terminal of the depletion mode FET is coupled to increase effective resistance of the ballast circuit in correspondence with increased current through the ballast circuit. In some cases or embodiments, the ballast circuit includes a transient voltage suppressor device coupled to provide the depletion mode FET with overvoltage protection. In some cases or embodiments, the ballast circuit includes a hysteresis circuit coupled to allow a resistance increasing bias to develop at the gate terminal more quickly than such a bias may be dissipated to return the depletion mode FET to a fully conductive state.

In some cases or embodiments, the apparatus further includes a high-voltage power supply coupled to supply the emitter and collector electrodes with a nominal energizing voltage in excess of 3 KV. In some cases or embodiments, the apparatus is configured as one of an electrostatic precipitator and an ozone generator.

In some embodiments in accordance with the present invention(s), a method of making an electrohydrodynamic (EHD) fluid mover includes: (i) providing a structural frame defining an open volume with exposed dielectric surfaces and positional registrations to receive an elongate wire emitter electrode and at least one collector electrode, the structural frame further defining a cavity to receive a ballast circuit; (ii) introducing the ballast circuit into the cavity and positionally fixing the ballast circuit therein; (iii) stringing the elongate wire emitter electrode across the open volume and past respective ones of the positional registrations at or adjacent surfaces of the structural frame that define sidewalls of the open volume; and (iv) at a position beyond one of the sidewalls but within the cavity, electrically connecting and mechanically fixing the elongate wire emitter directly to a termination point on the ballast circuit.

In some cases or embodiments, the method further includes: (v) prior to the stringing, fixing a first end of the elongate wire emitter electrode; and (vi) prior to the electrically connecting and mechanically fixing, tensioning the elongate wire emitter electrode strung across the open volume and past respective ones of the positional registrations.

In some cases or embodiments, the method further includes substantially filling the void and thereby substantially encapsulating the ballast circuit, including the termination point thereon and at least a portion of the elongate wire emitter electrode connected directly thereto, with a potting material.

In some cases or embodiments, the method further includes (vii) prior to the introduction of the ballast circuit into the cavity, at least partially filling the cavity with a first volume of uncured potting material; and (viii) after the electrical connection and mechanical fixation of the elongate wire emitter directly to a termination point on the ballast circuit, substantially filling remaining unfilled portions of the cavity with a second volume of the uncured potting material and thereafter curing at least the second volume of potting material to thereby encapsulate the ballast circuit, including the termination point thereon and at least the portion of the elongate wire emitter electrode connected directly thereto within cured potting material that, together with the encapsulated ballast circuit fills the substantial entirety of the cavity.

In some embodiments in accordance with the present invention(s), an electrohydrodynamic (EHD) fluid mover assembly includes a structural frame, a ballast circuit, and an elongate wire emitter electrode. The structural frame defines an open volume with exposed dielectric surfaces and positional registrations to receive the elongate wire emitter electrode and at least one collector electrode. The structural frame further defines a cavity to receive the ballast circuit. The ballast circuit is positioned within the cavity. The elongate wire emitter electrode is strung across the open volume and past respective ones of the positional registrations at or adjacent surfaces of the structural frame that define sidewalls of the open volume and, at a position beyond one of the sidewalls but within the cavity, is electrically connected and mechanically fixed directly to a termination point on the ballast circuit. In some cases or embodiments, an encapsulating volume of the cavity substantially surrounding the ballast circuit and the termination point thereon is filled with an ozone resistant potting material.

### BRIEF DESCRIPTION OF THE DRAWINGS

The present invention may be better understood, and its numerous objects, features, and advantages made apparent to those skilled in the art by referencing the accompanying drawings.

FIG. 1 illustrates basic principles of electrohydrodynamic (EHD) fluid acceleration.

FIG. 2 depicts an illustrative electrohydrodynamic (EHD) fluid mover configuration in which emitter and collector electrodes are energized to motivate fluid flow and in which a resistive ballast circuit closely coupled to the emitter electrode is employed to suppress sparking discharges in the emitter-to-collector gap.

FIGS. 3A and 3B depict cross-sectional and perspective views (respectively) of an illustrative electrohydrodynamic (EHD) fluid mover configuration in which emitter and collector electrode surfaces are cleaned and/or conditioned using a mechanism that drives a carriage with surfaces in frictional engagement therewith. A drive motor is controlled in accordance with some embodiments of the present invention(s) to apply, in situ, a consumable ozone catalyst or reducer. In some embodiments, certain field blunting structures and electrode shaping techniques may tend to reduce incidence or development of conditions that lead to sparking discharge and shunting currents.

FIGS. 4A, 4B, 4C, 4D and 4E depict various end-on and perspective views of an illustrative electrohydrodynamic (EHD) fluid mover configuration in accordance with some embodiments of the present invention and in which ballast circuit board is provided in a cavity sized and positioned to allow direct electrical attachment of a wire-type emitter electrode at or near a terminal end thereof. The cavity allows the ballast circuit board and electrical connections thereto to be electrically isolated within a surrounding body of potting compound introducible into the cavity.

FIGS. 5A, 5B, and 5C depict perspective, top and end-on views of an illustrative carriage for use in an electrohydrodynamic (EHD) fluid mover configuration such as described herein. Exemplary field blunting structures are employed on opposing lateral sides of the carriage, together with a downstream baffle portion integral with the carriage and various surfaces that facilitate frictional cleaning of collector electrode surfaces. An emitter electrode passes through the interior of the carriage and frictionally engages conditioning surfaces therein.

FIGS. 6A, 6B, and 6C respectively depict perspective, exploded detail and circuit views of ballast board aspects of an illustrative electrohydrodynamic (EHD) fluid mover configuration in accordance with some embodiments of the present invention.

FIGS. 7A, 7B, 7C and 7D depict various exemplary circuit realizations for ballast circuits suitable for inclusion on a circuit board to which an emitter electrode of a corona discharge type device may be directly connected to provide spark suppression in accordance with some embodiments of the present invention.

The use of the same reference symbols in different drawings indicates similar or identical items. System and device exploitations of the various configurations described and illustrated herein will be appreciated by persons of ordinary skill in the art having benefit of the present disclosure.

### DESCRIPTION OF EMBODIMENT(S)

As will be appreciated, many of the designs and techniques described herein have particular applicability to the thermal management challenges of densely-packed devices and small form-factors typical of modern consumer electronics. Indeed, some of the EHD fluid/air mover designs and techniques described herein facilitate active thermal management in electronics whose thinness or industrial design precludes or limits the viability of mechanical air movers such as fans, blowers, etc. In some embodiments, such EHD fluid/air movers may be fully integrated in an operational system such as a pad-type or laptop computer, a projector or video display device, a set-top box, etc. In other embodiments, such EHD fluid/air movers may take the form of subassemblies or enclosures adapted for use in providing such systems with EHD motivated flows.

In general, a variety of scales, geometries and other design variations are envisioned for electrostatically operative surfaces that provide field shaping or that functionally constitute a collector electrode, together with a variety of positional interrelationships between such electrostatically operative surfaces and the emitter and/or collector electrodes of a given EHD device. For purposes of illustration, we focus on certain exemplary embodiments and certain surface profiles and positional interrelationships with other components. For example, in much of the description herein, generally planar collector electrodes are formed as or on respective parallel surfaces that define opposing walls of a fluid flow channel and which are positioned proximate to a corona discharge-type emitter wire that is displaced (upstream) from leading portions of the respective collector electrodes. Nonetheless, other embodiments may employ other configurations or other ion generation techniques and will nonetheless be understood in the descriptive context provided herein.

For purposes of illustration and not limitation, contents of U.S. Provisional Application No. 61/612,892, filed Mar. 19, 2012, entitled “OPERATIONAL CONTROL OF ELECTROHYDRODYNAMIC (EHD) AIR MOVER AND ELECTRODE CONDITIONING MECHANISM” and of U.S. patent application Ser. No. 13/737,464, filed Jan. 9, 2013, entitled “ELECTROHYDRODYNAMIC (EHD) AIR MOVER CONFIGURATION WITH FLOW PATH EXPANSION AND/OR SPREADING FOR IMPROVED OZONE CATALYSIS” and naming Jewell-Larsen, Lee, Honer and Humpston as inventors are incorporated herein by reference. The '892 provisional application and the '464 application illustrate and describe certain laptop and display device deployments of EHD air movers. In addition, the '892 and '464 applications illustrate and describe variations on electrode geometries that, based on teachings herein, may be adapted to convey benefits and advantages analogous to those described herein. Further alternative EHD fluid mover configurations are detailed in application Ser. No. 13/310,676, filed Dec. 2, 2011, entitled “ELECTROHYDRODYNAMIC (EHD) FLUID MOVER WITH FIELD SHAPING FEATURE AT LEADING EDGE OF COLLECTOR ELECTRODES” and naming Jewell-Larsen as inventor, which is also incorporated herein by reference.

In the present application, some aspects of embodiments illustrated and described herein are referred to as electrohydrodynamic fluid accelerator devices, also referred to as “EHD devices,” “EHD fluid accelerators,” “EHD fluid movers,” “ion fluid movers” and the like. For purposes of illustration, some embodiments are described relative to particular EHD device configurations in which a corona discharge at, or proximate to, an emitter electrode operates to generate ions that are accelerated in the presence of an electrical field, thereby motivating fluid flow. While corona discharge-type fluid acceleration devices provide a useful descriptive context, it will be understood (based on the present description) that spark suppression ballast techniques described herein may also be employed in other corona discharge devices, such as ion generators and electrostatic precipitators.

Focusing illustratively on EHD fluid accelerator embodiments and thermal management system use cases, it will be understood that heat dissipated by electronics (e.g., microprocessors, graphics units, etc.) and/or other components can be transferred into an EHD motivated fluid flow and exhausted from an enclosure through a ventilation boundary. Typically, when a thermal management system is integrated into an operational environment, heat transfer paths (often implemented as heat pipes or using other technologies) are provided to transfer heat from where it is dissipated (or generated) to a location (or locations) within the enclosure where air flow motivated by an EHD device (or devices) flows over heat transfer surfaces.

For illustration, heat transfer fins are depicted with respect to various exemplary embodiments. However, as will be appreciated based on the description herein, in some embodiments, conventional arrays of heat sink fins need not be provided and EHD motivated fluid flow over exposed interior surfaces, whether proximate a heat generating device (such as a processor, memory, RF section, optoelectronics or illumination source) or removed therefrom, may provide sufficient heat transfer. In each case, provision of ozone catalytic or reactive surfaces/materials on heat transfer surfaces may be desirable. Typically, heat transfer surfaces, field shaping surfaces and dominant ion collecting surfaces of a collector electrode present differing design challenges and, relative to some embodiments, may be provided using different structures or with different surface conditioning. However, in some embodiments, a single structure may be both electrostatically operative (e.g., to shape fields or collect ions) and provide heat transfer into an EHD motivated fluid flow.

### Electrohydrodynamic (EHD) Fluid Acceleration, Generally

Basic principles of electrohydrodynamic (EHD) fluid flow are well understood in the art and, in this regard, an article by Jewell-Larsen, N. et al., entitled “Modeling of corona-induced electrohydrodynamic flow with COMSOL multiphysics” (in the Proceedings of the ESA Annual Meeting on Electrostatics 2008) (hereafter, “the Jewell-Larsen Modeling article”), provides a useful summary. Likewise, U.S. Pat. No. 6,504,308, filed Oct. 14, 1999, naming Krichtafovitch et al. and entitled “Electrostatic Fluid Accelerator” describes certain electrode and high voltage power supply configurations useful in some EHD devices. U.S. Pat. No. 6,504,308, together with sections I (Introduction), II (Background), and III (Numerical Modeling) of the Jewell-Larsen Modeling article are hereby incorporated by reference herein for all that they teach.

Summarizing briefly with reference to the illustration in FIG. 1, EHD principles include applying a high intensity electric field between a first electrode 10 (often termed the “corona electrode,” the “corona discharge electrode,” the “emitter electrode” or just the “emitter”) and a second electrode 12. Fluid molecules, such as surrounding air molecules, near the emitter discharge region 11 become ionized and form a stream 14 of ions 16 that accelerate in the electric field toward second electrode 12, colliding with neutral fluid molecules 17 in the process. As a result of these collisions, momentum is transferred from the stream 14 of ions 16 to the fluid molecules 17, imparting corresponding movement of the fluid molecules 17 in a desired fluid flow direction, denoted by arrow 13, toward second electrode 12. Second electrode 12 may be variously referred to as the “accelerating,” “attracting,” “target” or “collector” electrode. While stream 14 of ions 16 is attracted to, and generally neutralized by, second electrode 12, the momentum transferred to the neutral fluid molecules 17 carries them past second electrode 12 at a certain velocity. The movement of fluid produced by EHD principles has been variously referred to as “electric,” “corona” or “ionic” wind and has been defined as the movement of gas induced by the movement of ions from the vicinity of a high voltage discharge electrode 10.

EHD fluid mover designs illustrated herein generally include a single elongate wire, corona discharge type emitter electrode, although (more generally) multiple emitter electrodes and other emitter geometries may be employed. Typically, corona discharge type emitter electrodes include a portion (or portions) that exhibit(s) a small radius of curvature and may take the form of a wire, rod, edge or point(s). Other shapes for corona discharge electrodes are also possible; for example, the corona discharge electrode may take the shape of barbed wire, wide metallic strips, and serrated plates or non-serrated plates having sharp or thin parts that facilitate ion production at the portion of the electrode with the small radius of curvature when high voltage is applied. In general, corona discharge electrodes may be fabricated in a wide range of materials. For example, in some embodiments, a corona discharge type emitter electrode is formed of Palladium Nickel (PdNi) plated Tungsten (W) wire with a Rhodium (Rh) coating. U.S. application Ser. No. 13/302,811, filed Nov. 22, 2011, which is incorporated herein by reference, describes certain layered structures of drawn wire that, at diameters of 10-50 μm (typically less that about 25 μm) are suitable for EHD air mover devices of the illustrated designs with KV range emitter-to-collector voltages and scales typical of modern consumer electronics. In some embodiments, compositions such as described in U.S. Pat. No. 7,157,704, filed Dec. 2, 2003, entitled “Corona Discharge Electrode and Method of Operating the Same” and naming Krichtafovitch et al. as inventors may be employed. U.S. Pat. No. 7,157,704 is incorporated herein for the limited purpose of describing materials for some emitter electrodes that may be employed in some corona discharge-type embodiments. In general, a high voltage power supply creates the electric field between corona discharge electrodes and collector electrodes.

EHD fluid mover designs illustrated herein include ion collection surfaces positioned downstream of one or more corona discharge electrodes. Often, ion collection surfaces of an EHD fluid mover portion include leading surfaces of generally planar collector electrodes extending downstream of the corona discharge electrode(s). In small form factor designs that seek to minimize flow channel height, collector electrode surfaces may be positioned against, or may partially define opposing walls of, the flow channel. In some cases, a collector electrode may do double-duty as heat transfer surfaces. In some cases, a fluid permeable ion collection surface may be provided.

In general, collector electrode surfaces may be fabricated of, or with, any suitable conductive material or surface, such as aluminum or copper. Alternatively, as disclosed in U.S. Pat. No. 6,919,698 to Krichtafovitch, collector electrodes (referred to therein as “accelerating” electrodes) may be formed of a body of high resistivity material that readily conducts a corona current, but for which a result voltage drop along current paths through the body of high resistivity collector electrode material provides a reduction of surface potential, thereby damping or limiting an incipient sparking event. Examples of such relatively high resistance materials include carbon filled plastic, silicon, gallium arsenide, indium phosphide, boron nitride, silicon carbide, and cadmium selenide. U.S. Pat. No. 6,919,698 is incorporated herein for the limited purpose of describing materials for some collector electrodes that may be employed in some embodiments. Note that in some embodiments described herein, a surface conditioning or coating of high resistivity material (as contrasted with bulk high resistivity) may be employed.

### Illustrative EHD Air Mover and Energizing Power Supply

FIG. 2 depicts an illustrative EHD fluid mover configuration (with an illustrative power supply circuit schematic overlaid thereon) in which a high voltage power supply 190 is coupled between an emitter electrode 191 and collector electrodes 192 to generate an electric field and, in some cases, ions that motivate fluid flow 199 in a generally downstream direction. In the illustration, emitter electrode 191 is coupled to a positive high voltage terminal of power supply 190 (illustratively+6 KV, although specific voltages and, indeed, any supply voltage waveforms may be matters of design choice) and collector electrodes 192 are coupled to a local ground. Suitable designs for power supply 190 (and controls therefor) are detailed in the aforementioned U.S. Provisional Application No. 61/612,892, filed Mar. 19, 2012, and in U.S. Provisional Application No. 61/647,483, filed May 15, 2012, entitled “OPERATIONAL CONTROL OF AN ELECTROHYDRODYNAMIC (EHD) FLUID MOVER,” each of which is incorporated herein by reference.

Given the substantial voltage differential and short distances involved between emitter electrode 191 and leading surfaces of collector electrodes 192 (perhaps 5 mm or less, depending on EHD fluid mover scale), a strong electrical field is developed which imposes a net downstream motive force on positively charged ions (or particles) in the fluid. Field lines illustrate (generally) spatial aspects of the resulting electric field and spacing of the illustrated field lines is indicative of field strength.

As will be understood by persons of ordinary skill in the art, corona discharge principles may be employed to generate ions in the intense electric field closely proximate the surface of a corona-discharge type emitter electrode. Thus, in corona discharge type embodiments in accord with FIG. 2, fluid molecules (such as surrounding air molecules) near emitter electrode 191 become ionized and the resulting positively charged ions are accelerated in the electric field toward collector electrodes 192, colliding with neutral fluid molecules in the process. As a result of these collisions, momentum is transferred from the ions to neutral fluid molecules, inducing a corresponding movement of fluid molecules in a net downstream direction. While the positively charged ions are attracted to, and neutralized by, collector electrodes 192, the neutral fluid molecules move past collector electrodes 192 at an imparted velocity (as indicated by fluid flow 199). The movement of fluid produced by corona discharge principles has been variously referred to as “electric,” “corona” or “ionic” wind and has generally been defined as the movement of gas induced by the movement of ions from the vicinity of a high voltage discharge electrode. For avoidance of doubt, power supply voltage magnitudes, polarities and waveforms (if any) described with respect to particular embodiments are purely illustrative and may differ for other embodiments.

Because corona discharge devices such as the EHD fluid mover configuration of FIG. 2 tend to operate at voltages that approach breakdown voltage of the fluid (typically air) in the emitter-to-collector electrode gap, sparking discharge is a possibility. Likelihood of sparking discharge can increase based on the presence of entrained particulates, surface contaminants, deposits and dendritic growths on electrode surfaces and even environmental conditions or excursions in power delivered by a high voltage supply. Accordingly, multifaceted techniques have been developed to manage and mitigate sparking discharge. One of these techniques involves suppression of incipient sparking discharge using a closely coupled ballast (e.g., ballast circuit 270), that in correspondence with a spark indicative increase in current between emitter electrode 191 and collector electrodes 192 results in a rapid and responsive increase voltage drop across the closely coupled ballast.

The resulting voltage drop across the ballast (e.g., across ballast circuit 270) robs the emitter-to-collector gap of some of the voltage necessary to sustain a sparking discharge across the gap and tends to suppress the corona discharge-based process by which carriers are generated in the gap. By very closely coupling ballast circuit 270 to emitter electrode 191, time constants (RC- or LC-related) can be minimized such that temporal response of the emitter-to-collector gap voltage reduction is improved. In addition, stored energy available and peak sparking current (based on now negligible parasitic capacitance downstream of the ballast circuit 270) are minimized. Accordingly, acoustics of any sparking that does occur are likewise minimized. Description that follows (particularly that related to FIGS. 4A-4E and 6A-6C) emphasizes a direct connection of emitter electrode 191 (at or near a terminal end thereof) to an electrical and mechanical connection point (e.g., a solder bump) on a ballast circuit (e.g., a ballast circuit board). FIGS. 7A-7D illustrate exemplary ballast circuits that may be implemented and directly connected to emitter electrode 191.

As will be appreciated by persons of ordinary skill in the art having access to the present description, additional techniques may be applied to reduce the incidence of sparking discharge and shunting currents in EHD fluid movers. Additional techniques include the use of one or more cleaning and/or conditioning mechanisms and use of field blunting structures, collector shaping and/or flow baffles as summarized below and further detailed in documents incorporated by reference herein. In some embodiments, closely-coupled ballast techniques described and illustrated herein are used in combination with such additional techniques.

### Illustrative Cleaning/Conditioning Mechanism

FIGS. 3A and 3B depict (in respective cross-sectional and perspective views) an EHD air mover assembly 20 in which an upstream lead screw or worm gear 30 driven carriage 32 is provided to transit electrode conditioning and/or cleaning surfaces over at least a portion of an elongate, wire-type, mid-channel emitter electrode 91 and a pair of closely-spaced elongate collector electrode surfaces 92. When energized with high voltage (typically multi-KV voltage supplied from power supply terminals that have been omitted for clarity), an ion flux from emitter electrode 91 to collector electrodes 92 is generated and air flow 13 results based on mechanisms such as previously described.

In the illustrated cross-sectional view of FIG. 3A, EHD motivated airflow 13 travels past heat transfer surface(s) 16 (in some cases, a plurality of metallic fins) that may be thermally coupled (e.g., by heat spreader, heat pipe or the like) to heat surfaces for which a thermal management solution is to be provided. Dielectric top and bottom wall surfaces at least partially define a channel through which air flow is motivated and, in the illustrated embodiment, collector electrode surfaces 92 are positioned generally thereagainst. In situ cleaning and/or conditioning of respective electrode surfaces, including in situ conditioning of emitter electrode 91 with a conditioning material that includes silver (Ag) will understood based on the description herein.

Further details regarding cleaning/conditioning mechanisms for in situ application of a consumable catalyst that includes silver (Ag) to an emitter electrode of certain EHD air mover configurations such as illustrated herein may be found in U.S. patent application Ser. No. 13/602,256, filed Sep. 3, 2012, entitled “System and Method for In-Situ Conditioning of Emitter Electrode with Silver” and naming Jewell-Larsen, Honer, Gao and Schwiebert as inventors, which is incorporated herein by reference.

In the illustrated perspective view of FIG. 3B, an illustrative drive mechanism including lead screw or worm gear 30 driven carriage 32 is provided to transit electrode conditioning and/or cleaning surfaces over at least a portion of the elongate, wire-type, mid-channel emitter electrode 91 and a pair of closely-spaced elongate collector electrode surfaces 92. Drive motor and control circuits are operated in accord with the description herein to control operation of a drive motor that engages (typically with reduction gearing) the lead screw or worm gear 30. Further details (including drawings and description of suitable control circuits and strategies) may be found in the aforementioned U.S. Provisional Application Nos. 61/612,892, filed Mar. 19, 2012, and 61/647,483, filed May 15, 2012, each of which is incorporated herein by reference.

### Illustrative Field Blunting Structures, Collector Shaping and Baffles

FIGS. 4A, 4B, 4C, 4D and 4E depict various end-on and perspective views of an illustrative EHD air mover configuration in which a wire-type emitter electrode 91 is directly connected to ballast board 47 for spark suppression. Exemplary field blunting structures (e.g., sidewall-positioned field blunting structure 42 and carriage-positioned, field blunting structure 42A) are employed to reduce incidence of sparking discharge and shunting currents. Collector electrode shaping (e.g., tapered leading surfaces 44) and fluid flow impeding baffles are also employed in the illustrated design and are summarized below. Further detail is provided in U.S. Provisional Application Nos. 61/652,812, filed May 20, 2012, and 61/694,430, filed Aug. 29, 2012, each entitled “COMPACT ELECTROHYDRODYNAMIC (EHD) FLUID MOVER DESIGN” and each incorporated herein by reference.

Based on the present description, it will be understood that certain surfaces in an EHD air mover design (at least in compact designs at or below the scales illustrated and described herein) are particularly susceptible to accumulation of airborne contaminants and charge, which (in the presence of substantial electric fields) may, in turn, create conditions suitable for sparking discharge. Sidewalls of an EHD air mover channel adjacent to emitter and collector electrodes (or into which the lateral extent of such electrodes impinges) are one example of such susceptible surfaces. Another example, in some embodiments, is sidewalls of an electrode conditioning carriage configured to travel across an EHD air mover channel. EHD air mover designs illustrated and described herein employ several strategies to mitigate these susceptibilities which may otherwise lead to undesirable sparking discharge. In general, mitigation strategies may be used individually, or in combination, in various contemplated embodiments. Accordingly, mitigation strategies are described individually, but combined use will also be understood and appreciated based on the description herein.

A first such strategy includes use of structures to “blunt” the electric field in a spatially selective way near such susceptible surfaces. In general, the physical design of a corona discharge type emitter electrode seeks to focus electric field strength so as to establish and maintain a region of corona discharge closely proximate to the emitter electrode surface. However, by physically augmenting or scaling some of the electrode (or other physically or capacitively-coupled) surfaces that are coupled (or charge up) to emitter supply voltage, it is possible to locally increase the effective cross-section or radius of the emitter electrode at locations adjacent to the aforementioned susceptible surfaces. In this way, the strength of the electric field closely proximate to such susceptible surfaces can be reduced in an engineered and spatially selective way to below that necessary for corona onset. In such designs, ion generation and flux in the region closely proximate susceptible surfaces can be reduced and it has been discovered that, as a result, incidence of sparking discharge along otherwise susceptible sidewall surfaces may be effectively managed. Note that in some embodiments, the corona may be locally suppressed using field blunting structures while, in others, corona discharge may simply be reduced.

As explained elsewhere herein and/or as will be appreciated by persons of ordinary skill in the art having benefit of the present disclosure, corona discharge is, in general, sustainable in a region adjacent an emitter electrode and in which field strength is of sufficient intensity to ionize air molecules. For example, in embodiments such as described and illustrated herein (given a typical voltage of about 6 KV, emitter wire diameters of about 20 μm and emitter-to-collector electrode distances of about 2 mm), a corona may be sustained in conditions (e.g., temperature, pressure, humidity and constituents) typical for consumer electronics out to a few tens of microns from collector facing surfaces of the emitter wire. By distributing high voltage potential over an effectively larger emitter cross-section, field strength can be reduced in a spatially selective way near surfaces susceptible to sparking discharge proximate to locally suppress (or at least reduce) corona discharge. Thus, to locally provide an effectively-larger emitter cross-section, a sidewall-positioned field blunting structure 42 and a carriage-positioned, field blunting structure 42A are provided in the form of conductive metal tabs.

In the embodiment(s) illustrated in FIGS. 4A-4E, field blunting structures (42, 42A) are electrically connected to emitter electrode 91 potential. However, in other embodiments, field blunting structures may be coupled to a differing potential or supply. Furthermore, in some embodiments, one or more field blunting structures need not have an electrically conductive path to supply voltages, but may instead float to an electrostatically coupled potential (e.g., based on proximity to emitter electrode 91). While field blunting structures may be formed of ozone resistant conductive materials such as stainless steel or nickel based alloys, other materials such as polyether ether ketone (PEEK) or polycarbonates may be employed in some embodiments. Indeed, while conductive materials or coatings are suitable, it will understood based on the present description that materials or coatings in field blunting structures need not be particularly good conductors so long as some degree of electron mobility is provided.

In embodiments without a carriage, instances of field blunting structure 42 may be provided at opposing sidewalls. In embodiments in which a movable carriage (e.g., carriage 32) may be parked at one end (or the other) to, in effect, define a lateral sidewall of the EHD channel, a carriage-positioned, field blunting structure 42A may be provided. In embodiments in which it is desirable to energize electrodes (e.g., emitter electrode 91 and collector electrodes 92) when a movable carriage (e.g., carriage 32) is positioned, or is travelling, in the channel away from sidewalls (e.g., laterally mid-channel in the EHD air mover), instances (e.g., a pair) of carriage-positioned, field blunting structures 42A may be provided on opposing sides of the movable carriage and instances (e.g., a pair) of sidewall-positioned field blunting structures 42 may be provided at, or adjacent to, sidewalls of the EHD channel.

Although conductive metal tabs are illustrated (relative to FIGS. 4A-4E) for field blunting structures 42, 42A, other structures and materials may be employed to similar effect in other embodiments. For example, more bulbous and less streamlined structures may be employed in some embodiments though, perhaps, with somewhat reduced flow cross-section through the channel. Metallic field blunting structures are possible, as are field blunting structures formed of (or faced with) other materials including conductive plastics. Even structures formed of (or faced with) dielectric material may be employed in some embodiments to accumulate charge to effectively increase emitter cross-section, and thereby providing the field blunting effects described herein. Furthermore, while field blunting structures are illustrated (in FIGS. 4A-4E) as closely proximate to emitter wire 91, but structurally distinct therefrom, it will also be appreciated that, in some embodiments, field blunting structures may be formed integrally with, or affixed to, an emitter electrode. Note that field blunting structures are typically be positioned (or extend) just upstream of collector-facing surfaces of an emitter electrode so as not to, themselves, become part of a sparking discharge path.

FIGS. 5A-5C depict, in somewhat greater detail, a design for an illustrative movable carriage (e.g., carriage 32) in which a pair of carriage-positioned, field blunting structures 42A and 42B are provided. A larger one (42A) of the field blunting structures is configured to project into the EHD flow channel when carriage 32 is stowed (recall the stowed position illustrated in FIGS. 4A, 4C and 4E) against, or effectively as, a sidewall of the flow channel through the EHD air mover. Thus, during EHD air mover operation with carriage 32 stowed, i.e., when emitter and collector electrodes (91, 92) are energized with high voltage sufficient to establish a corona discharge, field blunting structure 42A provides corona suppression (or at least reduction) along a corresponding portion 599 of emitter electrode 91 adjacent the corresponding carriage sidewall that, in the stowed position (recall FIGS. 4A, 4C and 4E), in effect constitutes a sidewall of the flow channel through the EHD air mover.

In addition, an optional and, in the illustrated embodiment, smaller one (42B) of the field blunting structures is provided on the opposing sidewall of carriage 32. Although field blunting structure 42B is not readily discernible in the views of FIGS. 4A, 4C and 4E, it will be appreciated that an appropriate recess may be provided in the illustrated EHD air mover assembly frame to accommodate field blunting structure 42B, if provided. In those embodiments in which it is optionally provided, field blunting structure 42B provides corona suppression (or at least reduction) along a corresponding portion 598 of emitter electrode 91. In this way, corona suppression or reduction may be provided when carriage 32 is deployed within the flow channel through the EHD air mover. For example, in some embodiments, it may be desirable to continue to operate the EHD air mover with emitter and collector electrodes (91, 92) energized with high, though possibly reduced, voltage sufficient to establish a corona discharge even during carriage traversal across the flow channel. In such embodiments or operational modes, the pair of field blunting structures 42A, 42B, provide corona suppression or reduction adjacent to both sidewall surfaces of carriage 32 that may be susceptible to ion accumulation and sparking discharge if/when carriage 32 is traversing or positioned mid-channel.

Note that in the embodiments of carriage 32 illustrated in FIGS. 5A-5C, field blunting structure 42A exhibits greater lateral projection and provides more substantial field blunting than structure 42B so as to accommodate generally higher EHD operating power levels when carriage 32 is stowed (as compared to generally lower EHD operating power levels if/when carriage 32 is traversing or positioned mid-channel). Of course, in some embodiments, operating power levels may be more uniform and/or field blunting structures 42A and 42B may be more similarly sized.

Referring to FIGS. 4A-4E, additional strategies may be employed in some embodiments to mitigate susceptibilities to contaminant and charge accumulation, which may (as previously described) otherwise lead to undesirable sparking discharge. A second such strategy includes electrode shaping to reduce electric field strength in a spatially-selective way near sidewall surfaces susceptible to contaminant and/or charge accumulation.

In general, the physical design and relative positioning of emitter and collector electrodes seek to maximize a portion of the flow channel in which an electric field can accelerate charged airflow constituents (e.g., ions and/or charged particulate resulting from corona discharge). However, by creating or accentuating an emitter-to-collector gap near susceptible sidewall surfaces, it is possible to reduce the field conditions that can contribute to sparking discharge. Specifically, by locally increasing an emitter-to-collector gap (e.g., by providing collector taper 44 at or near sidewall surfaces and thereby locally increasing the distance between emitter 91 and collector 92 surfaces), both magnitude and shaping of the electric field can be defined in an engineered spatially selective way to guide ions and charged particulate away from sidewall surfaces and to reduce field strength at the sidewalls. In this way, both the propensity of susceptible sidewall surfaces to accumulate contaminants and charge and the susceptibility of such surfaces (even with some charge or contaminants accumulated thereon) to sparking discharge can be reduced.

Furthermore, and as described elsewhere herein, in those embodiments in which in situ electrode cleaning and conditioning is provided for either or both of an emitter electrode and a collector electrode (e.g., for emitter electrode 91 and collector electrodes 92 using carriage 32), it will be understood by persons of ordinary skill in the art having access to the present disclosure that the ability frictionally engage and effectively remove debris from electrode surfaces all the way up to an impingement on sidewall surfaces may be limited. See FIGS. 5A-5C for exploded detail on exemplary frictionally-engaged collector cleaning surfaces of carriage 32, particularly cantilever biased scraper 531 and pad surfaces 521, that in the more macro scale depictions of FIGS. 4A, 4C and 4E are configured to travel over and frictionally engage leading edges and exposed surfaces of collector electrodes 92, respectively.

By providing collector tapers 44 such as illustrated in FIGS. 4A, 4C, 4D and 4E at or near sidewall surfaces, it is possible to ensure that the major interior span of emitter and collector electrodes 91, 92 (in which emitter-to-collector voltage provides maximal field strength) is subject to a “full wipe” and those minor outer portions (coinciding generally with the illustrated collector electrode tapers 44) for which frictionally-engaged cleaning has limited reach are exposed to lesser field strength due to the increased local emitter-to-collector distance. For example, in the interior span (between the illustrated opposing end tapers 44), strength of the field may (given typical operating conditions and form factors) be in excess of 2 KV/mm, while strength of the field near tapers 44 and adjacent sidewalls may be less than 1.0-1.5 KV/mm.

Likewise, although a particular taper in leading surfaces of an upper/lower collector electrode configuration is illustrated, persons of ordinary skill in the art will appreciate a range of variations on shaping and presentation of leading surfaces to provide similar effect. In some embodiments, recesses may be provided in sidewalls of the flow channel and/or sidewall-positioned field blunting structure 42 and carriage-positioned, field blunting structure 42A may be just slightly offset relative to one another (e.g., in a vertical dimension) to allow more complete side-to-side travel of carriage 32. Note that in the embodiments illustrated in FIGS. 4A-4E, tapers 44 increase emitter-to-collector distance by 50-100% as compared to nominal values mid-channel and begin 5-10 mm from corresponding sidewalls (or effective sidewalls) of the EHD channel. Note that, notwithstanding the concreteness of the illustrated embodiments, specific distances, taper patterns and onsets are all matters of design choice and may differ in other embodiments or for differing conditions or operating environments.

Still yet a third strategy may be employed in some embodiments to complement either or both of the field blunting and collector shaping strategies described above to mitigate susceptibilities to contaminant and charge accumulation, which may (as previously described) otherwise lead to undesirable sparking discharge. Specifically, and again referring back again to FIGS. 4A-4E, fluid flow impeding baffles are provided as flow obstructing surfaces (46) to address effects of a low pressure well that may otherwise be induced in regions of diminished corona current or even corona suppression, such as for example, peripheral regions of an emitter-to-collector electrode gap adjacent sidewalls where either or both of the aforementioned design techniques (field blunting and collector shaping) have been employed.

To mitigate device inefficiencies that could otherwise result from a low-pressure-well-induced vortex and to limit contaminant delivering vortex-type flows at sidewalls, a fluid flow baffle is provided downstream of leading surfaces of the collector electrode. By interrupting a backflow path into the portion of the EHD channel adjacent to the sidewalls (or effective sidewall(s)), fluid flow baffles such as provided by surfaces 46 effectively prevent formation of a vortex involving peripheral lateral portions of the flow channel in which spatially selective corona suppression (or reduction) and/or field reduction tends to locally quench the motive EHD forces that are otherwise active in the major interior portion of the EHD channel.

Note that, in some embodiments, fluid flow baffles may be formed integrally with the trailing edge of collector electrode 92, such as with the baffle 46 instance illustrated in cutaway detail in FIG. 4D. Alternatively (or additionally), a similar fluid flow baffle may be provided further upstream such as within the gap between upper and lower surfaces of collector electrode 92. In such cases, it can be desirable to form baffle 46 of a conductive material, e.g., in some cases, monolithically with the conductive metal of collector electrode 92, itself. In general, it is desirable to position a fluid flow baffle close as possible to the sidewall-proximate portion of the emitter-to-collector gap where corona suppression and/or field suppression resulting from field blunting tab 42 and/or collector taper 44 creates the local absence (or reduction) in motive force conditions which may otherwise allow for formation of a low-pressure well induce vortex. Of course, electrostatic design complexity increases as the fluid flow baffle moves closer to (or indeed into) the emitter-to-collector gap. In addition, the ability to effectively clean or condition lateral extremities of electrode surfaces (e.g., in designs that employ a travelling carriage 32 such as illustrated and described herein) may be affected by baffle designs that place a rigid immovable baffle close to emitter electrode 91, leading surfaces collector electrode 92, or within the gap therebetween.

Notwithstanding the aforementioned complexities, embodiments are envisioned in which a fluid flow baffle (or an additional fluid flow baffle) is provided closer to (or indeed with) the emitter-to-collector gap. In some cases, a flexible baffle formed of dielectric material in of close to the emitter-to-collector gap may be provided and still accommodate electrostatic design goals and/or electrode surface cleaning/conditioning requirements. In some cases, a fluid flow baffle (or an additional fluid flow baffle) may be provided upstream of the emitter electrode.

More generally, desirable sizing and placement of fluid flow baffles is a function of localized corona current reductions or suppression (e.g., at sidewalls or adjacent a movable carriage) in a particular EHD device configuration. Based on the description herein, persons of ordinary skill in the art will appreciate a range of variations on shaping and placement of baffles to provide similar effect.

In addition to flow baffles at channel sidewalls (or effective sidewalls), it will be appreciated by persons of ordinary skill in the art having benefit of the present disclosure that similar issues present if/when the EHD air mover supports operational modes in which emitter and collector electrodes 91, 92 are energized with high, though possibly reduced, voltage sufficient to establish a corona discharge even during carriage traversal across the flow channel. In such embodiments or operational modes, the pair of field blunting structures 42A, 42B, provide corona suppression or reduction adjacent to both sidewall surfaces of carriage 32 and tend to locally quench the motive EHD forces that are active elsewhere in the EHD channel. As a result, it has been found to be advantageous to provide a back flow impeding baffle that travels with carriage 32. For example, in embodiments illustrated in FIGS. 5A-5C, a downstream projecting portion of the carriage 32 design, e.g., the biasing cantilever that urges scraper 531 against leading surfaces of collector electrodes 92, is engineered to provide a travelling flow impeding baffle 532 to backflows that might otherwise develop into vortices involving low pressure wells induced on either side of carriage 32 localized corona suppression (or reduction) described above relative to field blunting tabs 42A and 42B.

Referring back to FIGS. 4A-4E, several design aspects are notable relative to ballast-based spark suppression. First, a frame 48, typically formed (whether molded, machined or otherwise prepared) of non-conductive, dielectric material resistant to ozone, such as Dyron (PPE+PS), glass-filled Dyron, Balox (PC+PBT) with ultraviolet (UV) stabilizer, and/or ULTEM® (polyetherimide), provides positional anchors and, indeed, registrations for various of the illustrated constituent elements of the illustrated EHD fluid mover design, including electrodes, drive mechanisms, flow channel, etc. With more specific reference to spark suppression aspects, a cavity 49 is defined in frame 48 to receive a circuit board (ballast PCB 47) on or in which a ballast circuit such as described herein is defined. As illustrated, ballast PCB 47 provides a pair electrical attachment points at which emitter wire 91 and a high voltage supply are directly and respectively connected. Suitable circuit elements of ballast PCB 47 will be appreciated based on the description and drawings herein, but are omitted from FIGS. 4A-4E so as not to obscure positional relations of the spark suppression components.

Note that, for ease of viewing, an upper surface or lid of frame 48 assembly is omitted in the illustrated views. Also omitted from the illustrated views is encapsulation of ballast PCB 47 within a suitable potting compound such as an ozone resistant polyurethane. As will be appreciated, after emitter wire 91 and the illustrated high voltage supply are directly connected to ballast PCB 47 at suitable attachment points thereon, otherwise exposed high voltage surfaces may be encapsulated within non-conductive “potting” material. In some embodiments, for example, the substantial entirety of the volume of cavity 49 surrounding ballast PCB 47 may be filled with potting compound so as to isolate conductors that will, during operation of the illustrated EHD fluid mover, be energized to voltages of at least several KV.

FIGS. 6A, 6B, and 6C depict perspective, exploded detail and effective circuit views of ballast board aspects of an illustrative electrohydrodynamic (EHD) fluid mover 601 in accordance with some embodiments of the present invention. More specifically, exploded detail FIG. 6B shows direct attachment of emitter wire 91 to an electrical contact on ballast PCB 647. A narrow channel 691 between cavity 49 and the open central volume within frame 48 accommodates and provides positional registration (relative to collector electrodes 92) for emitter wire 91 along its approach to an electrical and physical attachment pad on ballast PCB 647. Emitter wire 91 is typically solder attached to ballast PCB 647.

FIG. 6C in turn illustrates a high voltage supply circuit from high voltage power supply (HVPS) 190, through ballast PCB 647, emitter electrode 91, the emitter-to-collector EHD air gap and collector electrode(s) 92 and back to HVPS 190. Solder attach points 694, 695 of ballast PCB 647 are illustrated together with an exemplary ballast circuit that may be defined therein or thereon. During typical energized operation of electrohydrodynamic (EHD) fluid mover 601, a high (typically multi-KV) voltage is established between emitter electrode 91 and collector electrode(s) 92 without substantial current across the EHD air gap such that current through (and therefore voltage drop across) resistor 699 and depletion mode field effect transistor (FET) 696 are negligible. Upon sparking or incipient sparking across the EHD air gap, current flow through resistor 699 and depletion mode FET 696 results in a voltage drop across ballast PCB 647 and a corresponding reduction in voltage between emitter electrode 91 and collector electrode(s) 92.

Because ballast PCB 647 is directly connected to a terminal end of emitter electrode 91, time constants are minimized and the response (i.e., voltage drop across ballast PCB 647) rapidly reduces emitter-to-collector voltage below that necessary to sustain an incipient spark. Typically, the corresponding rapid reduction in strength of the electric field proximate the emitter electrode 91 is to levels below that necessary to sustain corona discharge and generation of ions. As a result, an incipient sparking discharge is typically quenched or at least reduced in magnitude and duration. In the illustrated ballast PCB 647 circuit, an optional transient voltage suppression device 698 protects depletion mode FET 696 and an optional hysteresis or clamping circuit 697 facilitates rapid transition of depletion mode FET 696 from a maximally conductive state (ON) to a resistive state (OFF) while imposing a recovery time constraint on return to the maximally conductive state (ON) state.

Any of a number of commonly available electrical components may be used in the illustrated ballast PCB 647 circuit without substantially departing from the operational characteristics described. For purposes of illustration, and without limitation, several variations on the foregoing circuit realization are illustrated in FIGS. 7A, 7B, 7C and 7D. An effective resistance of between 100 KΩ and 0.5 MΩ is typical for PCB circuit 647A, 647B, 647C and/or 647D realizations suitable for exemplary embodiments and operating conditions described herein. In each case, the exemplary ballast circuit realization is suitable for inclusion in or on a circuit board to which an emitter electrode of a corona discharge type device may be directly connected to provide spark suppression in accordance with the teachings herein.

### Other Embodiments

While the techniques and implementations of the EHD devices discussed herein have been described with reference to exemplary embodiments, it will be understood by those skilled in the art that various changes may be made and equivalents may be substituted for elements thereof without departing from the scope of the appended claims. For example, while particular field blunting structures, collector tapers and baffle placements have been illustrated and described, persons of ordinary skill in the art having benefit of the present disclosure will appreciate that other suitable implementations are also contemplated. In some cases, field blunting structures or collector tapers or baffles illustrated and described herein may be omitted while still preserving some of the structures and/or advantages described herein.

Although operative embodiments have been illustrated and/or described herein with respect to a particular illustrative power supply voltage configuration in which emitter electrodes are coupled to high positive voltage, field shaping dielectric surfaces accumulate positive charge, and collector electrodes are coupled to ground, it will be appreciated by persons of ordinary skill in the art having access to the present disclosure that other configurations are also possible. Grounded emitter embodiments are contemplated, as are embodiments in which voltages coupled to emitter and collector electrodes straddle a ground potential or have different polarity.

In addition, many modifications may be made to adapt a particular situation or material to the teachings without departing from the essential scope thereof. Therefore, the particular embodiments, implementations and techniques disclosed herein, some of which indicate the best mode contemplated for carrying out these embodiments, implementations and techniques, are not intended to limit the scope of the appended claims.

What is claimed is:

1. An apparatus comprising:
an elongate wire emitter electrode and at least one collector electrode energizable to establish an ion current therebetween; and
a ballast circuit in direct electrical contact with the elongate wire emitter electrode to close at least a portion of a current path through the emitter and collector electrodes to, or from, a high voltage supply terminal.

2. The apparatus of claim 1,
wherein the ballast circuit includes a circuit board with a termination point to which one end of the elongate wire emitter electrode is soldered.

3. The apparatus of claim 2, further comprising:
a structural frame formed substantially of dielectric material and including a cavity in which the ballast circuit is positioned, the soldered end mechanically fixing the elongate wire emitter electrode under tension.

4. The apparatus of claim 3,
wherein an encapsulating volume of the cavity surrounding the ballast circuit and the soldered end of the elongate wire is substantially filled with potting material.

5. The apparatus of claim 4, wherein the potting material includes an ozone resistant polyurethane.

6. The apparatus of claim 1, configured as an EHD fluid mover to motivate fluid flow past the emitter and collector electrodes.

7. The apparatus of claim 6, further comprising:
an enclosure having inlet and outlet ventilation boundaries, the EHD fluid mover disposed within the enclosure to, when energized, motivate air flow along a fluid flow path therebetween; and
a heat source thermally coupled to transfer heat into the motivated air flow.

8. The apparatus of claim 1,
wherein the ballast circuit consists essentially of a resistive load providing between 100 KΩ and 0.5 MΩ of resistance in the current path.

9. The apparatus of claim 1,
wherein the ballast circuit includes a depletion mode field-effect transistor (FET) coupled into the current path.

10. The apparatus of claim 9,
wherein a gate terminal of the depletion mode FET is coupled to increase effective resistance of the ballast circuit in correspondence with increased current through the ballast circuit.

11. The apparatus of claim 9,
wherein the ballast circuit includes a transient voltage suppressor device coupled to provide the depletion mode FET with overvoltage protection.

12. The apparatus of claim 9,
wherein the ballast circuit includes a hysteresis circuit coupled to allow a resistance increasing bias to develop at the gate terminal more quickly than such a bias may be dissipated to return the depletion mode FET to a fully conductive state.

13. The apparatus of claim 1, further comprising:
a high-voltage power supply coupled to supply the emitter and collector electrodes with a nominal energizing voltage in excess of 3 KV.

14. The apparatus of claim 1, configured as one of an electrostatic precipitator and an ozone generator.

15. A method of making an electrohydrodynamic (EHD) fluid mover, the method comprising:
providing a structural frame defining an open volume with exposed dielectric surfaces and positional registrations to receive an elongate wire emitter electrode and at least one collector electrode, the structural frame further defining a cavity to receive a ballast circuit;
introducing the ballast circuit into the cavity and positionally fixing the ballast circuit therein;
stringing the elongate wire emitter electrode across the open volume and past respective ones of the positional registrations at or adjacent surfaces of the structural frame that define sidewalls of the open volume; and
at a position beyond one of the sidewalls but within the cavity, electrically connecting and mechanically fixing the elongate wire emitter directly to a termination point on the ballast circuit.

16. The method of claim 15, further comprising:
prior to the stringing, fixing a first end of the elongate wire emitter electrode; and
prior to the electrically connecting and mechanically fixing, tensioning the elongate wire emitter electrode strung across the open volume and past respective ones of the positional registrations.

17. The method of claim 15, further comprising:
substantially filling the void and thereby substantially encapsulating the ballast circuit, including the termination point thereon and at least a portion of the elongate wire emitter electrode connected directly thereto, with a potting material.

18. The method of claim 15, further comprising:
prior to the introduction of the ballast circuit into the cavity, at least partially filling the cavity with a first volume of uncured potting material; and
after the electrical connection and mechanical fixation of the elongate wire emitter directly to a termination point on the ballast circuit, substantially filling remaining unfilled portions of the cavity with a second volume of the uncured potting material and thereafter curing at least the second volume of potting material to thereby encapsulate the ballast circuit, including the termination point thereon and at least the portion of the elongate wire emitter electrode connected directly thereto within cured potting material that, together with the encapsulated ballast circuit fills the substantial entirety of the cavity.

19. An electrohydrodynamic (EHD) fluid mover assembly comprising:
a structural frame defining an open volume with exposed dielectric surfaces and positional registrations to receive an elongate wire emitter electrode and at least one collector electrode, the structural frame further defining a cavity to receive a ballast circuit;
the ballast circuit positioned within the cavity; and
the elongate wire emitter electrode strung across the open volume and past respective ones of the positional registrations at or adjacent surfaces of the structural frame that define sidewalls of the open volume and, at a position beyond one of the sidewalls but within the cavity, electrically connected and mechanically fixed directly to a termination point on the ballast circuit.

20. The electrohydrodynamic (EHD) fluid mover assembly of claim 19,
wherein an encapsulating volume of the cavity substantially surrounding the ballast circuit and the termination point thereon is filled with an ozone resistant potting material.
